(19) United States
(12) Patent Application Publication
(10) Pub. No.: US 2013/0005617 A1
(43) Pub. Date: Jan. 3, 2013

(54) SELF-DIVERTING EMULSIFIED ACID SYSTEMS FOR HIGH TEMPERATURE WELL TREATMENTS AND THEIR USE

(76) Inventors: Diankui Fu, Novosibirsk (RU); Galina Gennadievna Petukhova, Moscow (RU); Alexander Alexandrovich Burukhin, Novosibirsk (RU)

(21) Appl. No.: 13/174,101

(22) Filed: Jun. 30, 2011

(51) Int. Cl. C09K 8/74

(52) U.S. Cl. 507/230; 507/219; 507/221

(57) ABSTRACT

A method of treating a subterranean formation penetrated by a wellbore is carried out by introducing an emulsion composition into the formation through the wellbore wherein the formation has a formation temperature surrounding the wellbore of at least 120° C. The emulsion composition is formed from an aqueous acid component that forms an internal phase of the emulsion, non-aqueous component that forms an external phase of the emulsion, and a surfactant. The emulsion composition also includes an amount of fibers formed from high temperature polymer material. The high temperature polymer material is characterized by the property of not substantially degrading in water at pH<7 at temperatures below 80° C.

### FIELD OF THE INVENTION

This invention relates to compositions and methods for treating subterranean formations with acid at high temperatures.

### BACKGROUND

The statements made in this section merely provide information related to the present disclosure and may not constitute prior art, and may describe some embodiments illustrating the invention.

Treatment of subterranean formations with acid has been used for many years. Hydrochloric acid is especially useful, with the hydrochloric acid quickly dissolving carbonate materials of the formations. At high temperatures (e.g. above 120° C.), however, hydrochloric acid reacts so rapidly that it is difficult, if not impossible, for the acid to penetrate, or wormhole, more than a few inches into the formation. Additionally, at high temperatures the acid may corrode downhole equipment, such as pumping equipment, well tubing, casing, etc., making it difficult or undesirable to use.

Systems exist to retard the reaction of acid in high temperature environments. The use of organic acids, which are less reactive than hydrochloric acid or other mineral acids, have been used in high temperature applications. Chelating agents that retard the reaction of acid to provide increased formation penetration have also been used. Emulsified acid systems where acid is present as the internal phase of a water-in-oil emulsion have also been used. Commercially available acid emulsion systems may be obtained from Schlumberger Technology Corporations, Sugar Land, Tex.

One of the issues in treating subterranean formations with well treatment fluids is fluid loss. In stimulating the production of hydrocarbons, areas of low permeability are desirably treated to increase the production from such low permeable zones. When introducing treatment fluids, however, the fluids tend to flow into high permeable areas so that the fluid is lost to such zones and is less effective in treating the low permeable areas. Retarded acid systems are also characterized by increased viscosity compared to pure acid which leads to reduced fluid loss.

To prevent the loss of fluid to such high permeable areas, diverting agents may be used. Fibers are commonly employed in various treatments as diverting agents. The fibers will tend to block or close off the high permeable zones when the fluid is pumped into the formation so that the treatment fluid is then diverted to the less permeable areas where treatment is desired. Once the treatment is completed, however, it may be important that the fibers be removed so that they do not permanently affect the permeability of the formation. In such instances, degradable fibers may be used. One such degradable fiber material is polylactic acid (PLA). PLA has been the fiber of choice in many applications because of its degradation and mechanical properties. Polylactic acid, however, has an upper temperature limit of about 100° C., above which PLA fibers tend to quickly degrade. Therefore they may not be useful in high temperature applications. Certain fibers, such as metal, carbon, or fiberglass fibers, can be used in high temperature applications, however, they do not degrade even at high temperatures.

Other diverting systems that do not use fibers are known. Self-diverting acid systems that can be used at high temperature include those described in U.S. Pat. No. 7,380,602. The system described in this patent is a non-fiber, non-emulsified acid system that uses a mixture of acid, a chelating agent to retard reaction of the acid and a betaine surfactant. While effective, fluids employing such chelating agents and betaine surfactants are costly.

Accordingly, there exists a need for other self-diverting acid treatment systems that can be used in high temperature environments and that do not permanently plug or damage the formation.

### SUMMARY

Embodiments of the invention relate to an apparatus and a method of treating a subterranean formation penetrated by a wellbore is carried out by introducing an emulsion composition into the formation through the wellbore wherein the formation has a formation temperature surrounding the wellbore of at least 120° C. The emulsion composition is formed from an aqueous acid component that forms an internal phase of the emulsion, non-aqueous component that forms an external phase of the emulsion, and a surfactant. The emulsion composition also includes an amount of fibers formed from high temperature polymer material. The high temperature polymer material is characterized by the property of not substantially degrading in water at pH<7 at temperatures below 80° C.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

Embodiments of the present invention are directed toward an emulsified acid system for use in treating carbonate formations of oil and gas wells. Emulsified fluids have been used as treating fluids for various applications, which may be an oil-in-water emulsion (oil internal phase) or a water-in-oil emulsion (water internal phase). Various emulsions are described in U.S. Patent App. Pub. No. US2010/0029516A1, which is herein incorporated by reference in its entirety for all purposes. Embodiments of the present invention make use of a water-in-oil (“w/o”) emulsion, wherein an aqueous acid phase constitutes the internal phase of the emulsion. By incorporating the acid as the internal phase, the reaction of the acid is delayed so that it does not quickly react at high temperatures with the formation or other components of the well and can penetrate more deeply into the pores and flow paths of the formation. The emulsion system may not utilize any chelating agent component to retard the acid. Moreover, by incorporating a degradable fiber component with the emulsified acid system, the acid can be diverted from areas of high permeable to other zones of interest where acid treatment is desired.

The external oil phase of the emulsion is formed from a non-aqueous fluid or component. The non-aqueous component may be any suitable liquid or compound. Typically, a hydrocarbon liquid is used as the non-aqueous component. Non-limiting examples of suitable liquids for the non-aqueous component include diesel, kerosene, mineral oil, crude oil, vegetable oil, synthetic oil, or hydrocarbon which has 6 carbon or more.

The internal aqueous phase is an aqueous acid. Typically the acid is aqueous hydrochloric acid, although other acids or combinations of acids, including mineral and organic acids, may be used. Non-limiting examples of suitable mineral acids may include hydrochloric acid, nitric acid, sulfuric acid, boric acid, hydrofluoric acid, phosphoric acid, and tetrafluoroboric acid. Non-limiting examples of suitable organic acids may include formic acid, acetic acid, citric acid, lactic acid, methyl sulfonic acid, ethyl sulfonic acid, benzoic acid, and benzenesulfonic acid. The acid may be used in an amount and at a concentration that facilitates the effective acid treatment of the zone of interest. The water used for the aqueous phase may be fresh water, sea water, brine, and/or formation water (water produced from a well), etc.

The emulsified acid is typically formulated to provide a oil/acid ratio in the range from 20:80 to 80:20 by volume, more typically from 30:70 to 70:30 by volume.

Emulsifiers or surfactants are also used with the emulsified acid system. These surfactants and their quantities may be selected based upon the emulsion being prepared and the desired emulsion stability at certain formation temperature. The surfactants may be selected based on the well known hydrophile-lipophile balance (HLB) number, which is an indication of the relative strength of the hydrophilic and hydrophobic portions of the surfactant molecule. Surfactants having a low HLB number, for example from about 3 to about 6, may be used in forming stable oil continuous phase emulsions. The Phase Inversion Temperature approach may also be used to determine the usefulness of certain surfactants or stabilizers. The surfactants may be cationic, anionic, zwitterionic or non-ionic surfactants. The surfactants may be used in the emulsion system in an amount of from greater than 0 to about 10% by weight of the emulsion, more particularly from about 0.1% to about 5% by weight of the emulsion, and still more particularly from about 0.2% to about 2% by weight of the emulsion. Non-limiting examples of suitable surfactant materials include Sorbitan Trioleate HLB=1.8 Propylene Glycol Isostearate HLB=2.5 Glycol Stearate HLB=2.9 Sorbitan Sesquioleate HLB=3.7 Glyceryl Stearate HLB=3.8 Lecithin HLB=4 Sorbitan Oleate HLB=4.3 Sorbitan Monostearate NF HLB=4.7 Sorbitan Stearate HLB=4.7 Sorbitan Isostearate HLB=4.7 Steareth-2 HLB=4.9 Oleth-2 HLB=4.9 Glyceryl Laurate HLB=5.2 Ceteth-2 HLB=5.3 PEG-30 Dipolyhydroxystearate HLB=5.5 Glyceryl Stearate SE HLB=5.8, Sorbitan Monostearate NF HLB=4.7 Sorbitan Oleate HLB=4.3 Sorbitan Sesquioleate HLB=3.7 Sorbitan Stearate (and) Sucrose Cocoate HLB=6 Sorbitan Stearate HLB=4.7 Sorbitan Trioleate HLB=1.8.

The emulsion system further includes an amount of fibers. The fibers may be selected to provide a minimal decrease in the stability of emulsion. In many cases the fibers may actually facilitate increased stabilization of the emulsion. Typically, the fibers are hydrophobic fibers that are readily dispersed in the oil or non-aqueous phase of the emulsion. Such hydrophobic characteristic may be provided by the fiber materials themselves or by hydrophobic surface coatings provided on the fibers.

The fibers include those formed from high temperature polymer materials that are characterized by the property of not substantially degrading in water at neutral pH and in acidic environment ((i.e. pH<7) below temperatures of 110° C., 120° C., or 130° C. or not substantially dissolving in oil phase below temperatures of 120° C. or 130° C. Generally, in some environments the boundary is about 225 F, 110° C. Such high temperature polymer materials, however, may degrade in low pH (i.e. <7 pH) and/or be soluble in the non-aqueous fluids of the oil phase at temperatures above 110° C., 120° C., 130° C. or higher and can be used in forming degradable fiber systems for use in high temperature applications. As used herein, the expression “not substantially degrading” or similar expressions used herein with respect to the high temperature polymers is meant to encompass those materials that exhibit the following properties. The fiber should be stable at temperature above 110° C. at pH<7, including strong acidic environment where pH is less than 0 during the time of pumping, i.e less than 15% mass loss in 5 hours in acidic environment at temperatures above 110° C.

Suitable high temperature polymer fiber materials may include those described in U.S. patent application Ser. No. 13/167213, filed Jun. 23, 2011, entitled, “Degradable Fiber Systems for Well Treatments and Their Use,” which is herein incorporated in its entirety for all purposes. In certain embodiments, the high temperature polymers are formed from polyester and polyamide materials. Specific examples of the suitable high temperature polymers formed from polyester and polyamide materials include polyethylene terephthalate (PET), nylon 6,6, nylon 6 (polycaprolactam), nylon 11, nylon 6,12, and natural polyamides, such as polypeptides. In certain applications, high temperature polymers that are not based on diacids may be used. Such materials may degrade to form byproducts that may be sensitive to the composition of the formation fluids they encounter. For example, PET and nylon 6,6 both degrade or hydrolyze into diacids. Formations where divalent or multivalent ions, such as Ca²+ and Mg²+ cations, are present may tend to react with the formed diacids and precipitate out of solution. Therefore, in instances where polyvalent ions may be present, polymers that do not form such diacids may be used. These may include those materials formed from polyhydroxycarboxylic acids, polyaminoacids, and copolymers of these materials, such as nylon 6 and nylon 11.

Other high temperature polymers for the fiber material may include polyolefins, polyvinyl alcohols, and aromatic polymer materials (PET also constitutes a aromatic polymer material). Generally, polyolefins are oil soluble at high temperatures, polyvinyl alcohols are water soluble, aromatic polyesters such as PET are degradable. The polyolefins may include ethylene, propylene and butylene polymers, or those polyolefins formed from monomers having a monomer chain length of C6 or less. Such olefin polymers may include homopolymers as well as copolymers of different monomers. Polyvinyl alcohols may also be used for the fibers and may include co-polymers of PVA with other olefins. Aromatic polymer materials may include polyethylenenaphthalate.

The high temperature polymer fibers may have a variety of configurations. As used herein, the term “fiber” is meant to include fibers as well as other particulates that may be used as or function similarly to fibers for the purposes and applications described herein, unless otherwise stated or as is apparent from its context. These may include various elongated particles that appear as fibers or are fiber-like. The fibers may be straight, curved, bent or undulated. Other non-limiting shapes may include generally spherical, rectangular, polygonal, etc. The fibers may be formed from a single body or multiple bodies that are bound or coupled together. The fibers may be comprised of a main fiber body having one or more projections that extend from the main body, such as a star-shape. The fibers may be in the form of platelets, disks, rods, ribbons, etc. The fibers may also be amorphous or irregular in shape and be rigid, flexible or plastically deformable. Fibers may be used in bundles. A combination of different shaped fibers may be used and the materials may form a three-dimensional network within the fluid with which they are used. The fibers may have a length of less than about 1 mm to about 30 mm or more. In certain embodiments the fibers may have a length of 12 mm or less with a diameter or cross dimension of about 200 microns or less, with from about 8 microns to about 200 microns being typical. In certain applications the fibers may have a diameter or cross dimension of from about 8 to 12 microns. The fibers may have a ratio between any two of the three dimensions of greater than 5 to 1. In certain embodiments, the fibers may have a length of greater than 1 mm, with from about 1 mm to about 30 mm, from about 2 mm to about 25 mm, from about 3 mm to about 20 mm, and from 4 mm to about 12 mm being typical. In certain applications the fibers may have a length of from about 1 mm to about 10 mm (e.g. 6 mm). In certain embodiments, the fibers or elongated materials may have a diameter or cross dimension of from about 5 to 100 microns.

The fibers may be used in the emulsion in various amounts to provide the desired diversion and so that they do not sub substantially inhibit or negatively affect the stability of the emulsion. Typical ranges for the amount of fibers used in the emulsion are from about 40 lbs/1000 gals (4.79 g/L) to about 200 lbs/1000 gals (23.95 g/L), more particularly from about 80 lbs/1000 gals (9.58 g/L) to about 160 lbs/1000 gals (19.16 g/L), still more particularly from about 80 lbs/1000 gals (11.98 g/L) to about 120 lbs/1000 gals (14.37 g/L).

In certain embodiments, the high temperature polymer fibers may be used in conjunction with a fiber degrading accelerant, such as described in U.S. patent application Ser. No. 13/167213. The fiber degrading accelerants may be used in a similar manner as described therein. The fiber degrading accelerant facilitates degrading of the fibers at those temperatures in which the high temperature polymer fibers are used and can be any material that facilitates such degradation. The particular fiber degrading accelerant may be selected, designed and configured to provide a selected degradation rate at selected temperatures and conditions in which the fibers are to be used. For example, the fiber degrading accelerant may facilitate providing a fiber degradation rate of about 20%, 30%, 40%, 50%, 60%, 70%, 80%, 90% up to 100% fiber degradation or less over a period of from about 1 day to about 30 days at downhole temperature conditions. Typically, the fiber degrading accelerant will be a pH adjusting material, such as a base, an acid, or a base or acid precursor that forms bases or acids in situ. The fiber degrading accelerant may also be an oxidizer.

Another fiber degrading accelerant includes other degradable polymers. The degradable polymers used as the fiber degrading accelerant may be characterized in that they degrade more readily than the high temperature polymers at certain conditions, such as lower temperature, and they facilitate the degradation of the high temperature fibers. This may include degradation of the polymer into species that facilitate the degradation of the high temperature polymer fibers. These may be “polymeric acid precursors” that are typically solids at room temperature. The polymeric acid precursor materials may include the polymers and oligomers that hydrolyze or degrade in certain environments under known and controllable conditions of temperature, time and pH to release acids. The acids formed from such polymers may be monomeric acids but may also include dimeric acid or acid with a small number of linked monomer units that function similarly, for purposes of the invention described herein, to monomer acids composed of only one monomer unit.

Non-limiting examples of such degradable polymers for use of the fiber degrading accelerant include polymers and copolymers of lactic acid, glycolic acid, vinyl chloride, etc., and combinations of these. The degradable polymer acid precursors may include those that are described in U.S. Pat. Nos. 7,166,560; 7,275,596; 7,380,600; 7,380,601; 7,565,929, and in European Patent No. 1556458, each of which is incorporated herein by reference for all purposes. Polylactic acid (PLA) and polyglycolic acid (PGA) degrade to form the organic acids of lactic acid and glycolic acid, respectively. Polyvinyl chloride (PVC) degrades to form the inorganic acid of hydrochloric acid.

In one embodiment, the fiber degrading accelerant materials are incorporated into the high temperature polymer fibers themselves. This may be accomplished through mixing, blending or otherwise compounding the fiber degrading accelerant materials with the base polymer used to form the high temperature polymer fibers before the polymers are extruded or otherwise formed into fibers. This may include any of the fiber degrading accelerant materials previously discussed provided they are capable of being mixed, blended or compounded with the base polymers prior to extrusion or the formation of the fibers and do not negatively affect the emulsion stability or dispersion of the fibers in the non-aqueous phase, such as affecting the hydrophobic nature of the fibers. The additive materials to the fibers may be substantially uniformly distributed throughout the individual fiber matrix in this manner. Alternatively, the additive may be non-uniformly distributed throughout the fiber. Incorporating the fiber degrading accelerant into the fiber ensures that the degrading accelerant remains with the fibers in the treatment fluid and contributes to their degradation once in place. Particularly well suited for this application are the low temperature degradable polymer materials previously discussed. In certain instances, the fiber degrading accelerant may be incorporated with the fiber by applying the degrading accelerant as a coating that is applied to the already formed high temperature polymer fibers.

In another embodiment, the high temperature polymer fibers are formed as bi- or multi-component fibers with other degradable polymers, such as those previously described. In such instances, the polymers are not blended or compounded together prior to extrusion but are coextruded or formed separately as separate components of the same fiber. This may be accomplished, for example, by coextrusion where separate streams of each polymer component is directed from a supply source through a spinning head (often referred to as a “pack”) in a desired flow pattern until the streams reach the exit portion of the pack (i.e. the spinnerette holes) from which they exit the spinning head in the desired multi-component relationship. The formation of multi-component polymer fibers is described in U.S. Pat. No. 6,465,094, which is herein incorporated in its entirety for all purposes. The various components of the multi-component fibers may be arranged and configured in a variety of different configurations, such as sheath-core fibers with single or multiple cores, different layers, etc. In certain embodiments, the degradable polymer degrading accelerant forms the core or cores, with the high temperature polymer forming the sheath or outer layer. The multi-component fibers may be configured in the same overall shapes, sizes and configurations to those fibers previously described.

Acid itself may contain corrosion inhibitors, anti-sludging agents and corrosion inhibitor acid, etc.

The emulsion system is typically prepared at the surface. The aqueous acid together with the surfactant and non-aqueous liquid or oil are mixed together to form the emulsion. The fibers may then be added to the emulsion. In another embodiment, all or some of the fibers may be added to the non-aqueous liquid prior to mixing with the aqueous acid. The emulsion may be prepared in a batch process or a continuous process (on the fly) with the various components being mixed together as described above. In a continuous process the emulsion may be prepared during introduction into the wellbore by agitation of the components within the wellbore as they are pumped downhole. The fibers may facilitate stabilization of the emulsion so that less surfactant may be necessary than in acid emulsions prepared without the use of fibers. Furthermore, the emulsion may be used without any viscosifier or gelling agent.

The acid emulsion system with the incorporated fibers may be used in wells where the formation temperatures of the well or those temperatures where the fibers are to be used may be from about 120° C., 130° C., 140° C., 150° C., 160° C., 170° C., 180° C., 190° C., 200° C. or more.

The emulsion system prepared as described above may be used in matrix acidizing in carbonate formations wherein the emulsion is pumped into the well below the fracture pressure of the formation. The emulsified acid will initially have sufficient viscosity to disperse, suspend and transport the fibers into the formation. Upon entering the formation, the fibers form bridged networks, which may be either near the wellbore or inside wormholes, to reduce injectivity and allow more acid emulsion to move to other zones. During production, the fibers will degrade upon contact with spent or released acid or will dissolve in the oil that forms part of the emulsified system under the high downhole temperatures. In systems where the fibers are used in conjunction with a fiber degrading accelerant, the accelerant will facilitate degrading of the fibers downhole.

Besides matrix acidizing, the acid emulsion systems can be used for other treatments as well. The acid emulsions can be used in acid fracturing where the emulsion is pumped or introduced into the wellbore above the fracture pressure of the formation. They can be used in the removal of carbonate filter cake, such as in near wellbore region of horizontal wells. The emulsions can also be used in the removal of carbonate scales in sand screens. The acid emulsions employing the fibers can be used in any other treatments where acid treatment in combination with temporary fluid diversion is desired and wherein the emulsion is used in high temperature environments. Some embodiments of the emulsion system may benefit from removal of carbonate scales in sand screens or other downhole tubulars.

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

We claim:

1. An emulsion composition for use in treating a well of a subterranean formation having a formation temperature of at least 120° C., the composition comprising:
an aqueous acid component that forms an internal phase of the emulsion;
a non-aqueous component that forms an external phase of the emulsion;
a surfactant; and
an amount of fibers formed from high temperature polymer material, the high temperature polymer material being characterized by the property of not degrading in water at neutral and low pH at temperatures below 80° C.

2. The composition of claim 1, wherein the high temperature polymer material is selected from at least one of polyolefin, polyester, polyamide, polyvinyl alcohols, and aromatic polymer materials.

3. The composition of claim 1, wherein the high temperature polymer material is selected from at least one of polyethylene, polypropylene, polybutylene, nylon 6, nylon 6,6, nylon 6,12, nylon 11, polypeptides, polyurethane, polyethylene terephtalate, polyhydroxycarboxylic acids, polyaminoacids, polyethylenenaphthalate, or a combination thereof

4. The composition of claim 1, wherein the ratio of oil phase to aqueous phase of the emulsion ranges from 20:80 to 80:20 by volume.

5. The composition of claim 1, wherein the fibers are present in the emulsion in an amount of from about 0.1% to about 4.5% by weight of the emulsion.

6. The composition of claim 1, wherein the surfactant is present in the emulsion in an amount of from about 0.2% to about 2% by weight of the emulsion.

7. The composition of claim 1, wherein the non-aqueous component is selected from at least one of diesel, kerosene, crude oil, mineral oil, vegetable oil, synthetic oil, and hydrocarbons with 6 carbon atoms or more, or a combination thereof.

8. The composition of claim 1, wherein the aqueous acid is selected from at least one of hydrochloric acid, sulfuric acid, formic acid, nitric acid, acetic acid, boric acid, lactic acid, methyl sulfonic acid, ethyl sulfonic acid, hydrofluoric acid, phosphoric acid, tetrafluoroboric acid, benzoic acid, benzenesulfonic acid, or a combination thereof.

9. The composition of claim 1, wherein the fibers are hydrophobic.

10. The composition of claim 1, wherein a fiber degrading accelerant is incorporated into at least some of the fibers.

11. A method of treating a subterranean formation penetrated by a wellbore, the method comprising:
introducing an emulsion composition into the formation through the wellbore wherein the formation has a formation temperature surrounding the wellbore of at least 120° C., the emulsion composition comprising:
an aqueous acid component that forms an internal phase of the emulsion;
a non-aqueous component that forms an external phase of the emulsion;
a surfactant; and
an amount of fibers formed from high temperature polymer material, the high temperature polymer material being characterized by the property of not substantially degrading in water at pH<7 at temperatures below 80° C.

12. The method of claim 11, wherein the high temperature polymer material is selected from at least one of polyolefin, polyester, polyamide, polyvinyl alcohols, and aromatic polymer materials.

13. The method of claim 11, wherein the high temperature polymer material is selected from at least one of polyethylene, polypropylene, polybutylene, nylon 6, nylon 6,6, nylon 6,12, nylon 11, polypeptides, polyurethane, polyethylene terephtalate, polyhydroxycarboxylic acids, polyaminoacids, or a combination thereof.

14. The method of claim 11, wherein the ratio of oil phase to aqueous phase of the emulsion ranges from 20:80 to 80:20 by volume.

15. The method of claim 11, wherein the fibers are present in the emulsion in an amount of from about 0.1% to about 2% by weight of the emulsion.

16. The method of claim 11, wherein the surfactant is present in the emulsion in an amount of from about 0.2% to about 2% by weight of the emulsion.

17. The method of claim 11, wherein the non-aqueous component is selected from at least one of diesel, kerosene, crude oil, mineral oil, vegetable oil, synthetic oil, and hydrocarbons with 6 carbon atoms or more, or a combination thereof.

18. The method of claim 11, wherein the aqueous acid is selected from at least one of hydrochloric acid, sulfuric acid, formic acid, nitric acid, acetic acid, boric acid, lactic acid, methyl sulfonic acid, ethyl sulfonic acid, hydrofluoric acid, phosphoric acid, tetrafluoroboric acid, benzoic acid, benzenesulfonic acid, or a combination thereof.

19. The method of claim 11, wherein the fibers are hydrophobic.

20. The method of claim 11, wherein a fiber degrading accelerant is incorporated into at least some of the fibers.
